(19) United States
(12) Patent Application Publication
(10) Pub. No.: US 2025/0217508 A1
(43) Pub. Date: Jul. 3, 2025

(54) QUANTIFYING MACHINE-LEARNING MODEL RESILIENCE AGAINST INFERENCE ATTACKS

(71) Applicant: Microsoft Technology Licensing, LLC, Redmond, WA (US)

(72) Inventors: Giovanni CHERUBIN, London (GB); Boris Alexander KÖPF, Cambridge (GB); Andrew James PAVERD, Cambridge (GB); Shruti Shrikant TOPLE, Cambridge (GB); Lukas WUTSCHITZ, London (GB); Santiago Jose ZANELLA BEGUELIN, Cambridge (GB)

(21) Appl. No.: 18/400,422

(22) Filed: Dec. 29, 2023

(51) Int. Cl. G06F 21/56; G06N 7/01; G06N 20/00

(52) U.S. Cl. CPC G06F 21/56; G06N 7/01; G06N 20/00; G06F 2221/034

(57) ABSTRACT

Approximate closed-form bounds of Bayes security against record-level inference attacks, in particular membership and attribute inference attacks, are provided. In various embodiments, these approximate bounds of Bayes security are used in conjunction with training neural-network models by differential-privacy stochastic gradient descent to create trained models that achieve a desired level of privacy.

### BACKGROUND

Training artificial-intelligence (AI) or, synonymously, machine-learning (ML) models on private data presents a risk of inferential information disclosure, that is, the leakage of private training data used to create the model to users that have access to the trained model, e.g., via the model weights or an inference interface to the model. Attempts to glean private data from the model are generally referred to as “privacy attacks” or “inference attacks.” To minimize vulnerability to such attacks, it is standard practice to train the model using privacy-preserving algorithms, such as differentially-private stochastic gradient descent (DP-SGD). Further, it is desirable to quantify the remaining “privacy loss,” or conversely, the achieved “security” against inference attacks to be able to provide privacy guarantees.

### BRIEF DESCRIPTION OF THE DRAWINGS

Described herein, with reference to the accompanying drawings, are systems and methods for quantifying the security of a machine-learning model against inference attacks in terms of Bayes security.

FIG. 1A is a block diagram of an example computing system for the differentially private training of machine-learning models and quantification of the resulting Bayes security in accordance with various embodiments.

FIG. 1B is a block diagram of an example computing system deploying a trained machine-learning model, such as results from training a model in the system of FIG. 1A.

FIG. 2 is pseudocode illustrating an example DP-SGD algorithm.

FIGS. 3A and 3B are graphs, determined using example datasets, of Bayes security against membership inference attacks and attribute inference attacks, respectively, as a function of trained model accuracy.

FIG. 4 is an example graph illustrating the selection of a combinations of sampling rate and noise to achieve a desired level of Bayes security at a given number of training steps, in accordance with one embodiment.

FIG. 5A is a flowchart of an example machine-learning method for protecting against membership inference attacks, in accordance with one embodiment.

FIG. 5B is an example screen layout of a software tool for adjusting training hyperparameters to achieve a desired level of Bayes security against membership inference attacks, in accordance with one embodiment.

FIG. 6 is pseudocode illustrating a modified DP-SGD algorithm for quantifying Bayes security against attribute inference attacks, in accordance with one embodiment.

FIGS. 7A-7D are flowcharts of example machine-learning methods for protecting against attribute inference attacks, in accordance with various embodiment.

FIG. 8 is a block diagram of an example computing machine that may be configured to perform the computational methods described herein.

### DESCRIPTION

Described herein are computer-implemented systems and methods for machine-learning model training and deployment that use closed-form bounds of Bayes security against record-level inference attacks to facilitate better protecting against these attacks by improving the trade-off between model accuracy and the achieved level of privacy. Various embodiments, more specifically, quantify Bayes security against “membership inference” and “attribute inference” attacks. In membership inference attacks, the attacker attempts to infer whether specific data records, or groups of records, were part of the model's training data. In attribute inference attacks, the attacker attempts to infer sensitive attributes of one or more records that were part of the training data. The disclosed approach to obtaining Bayes security values is applicable to any type of machine learning models trained using DP-SGD, including, but not limited to, linear support vector machines, logistic regression models, and neural networks.

DP-SGD is the most widely-used privacy-preserving learning algorithm for neural networks. It enables the model creator to quantify the privacy loss in terms of two privacy parameters, ε and δ, which depend on various training hyperparameters chosen by the model creator, such as: the number of training iterations (also “training steps”)(T); the sampling rate (p), corresponding to the expected or average number of data records used per training step (L) divided by the total number of data records in the training data (N); the gradient norm clipping parameter (C); and the DP-SGD noise multiplier (σ). However, the (ε, δ) values of a trained model capture the generic risk of leaking any information about individual records, and are usually applied in a threat-agnostic manner.

To quantify the resilience of a trained model against specific types of attacks, such as membership inference and attribute inference, it is desirable to evaluate metrics such as “attacker advantage” (or simply “advantage”) or “Bayes security.” The attacker advantage quantifies the advantage gained by the attacker, for a specific attack, when given access to the trained model; more precisely, it is defined as the difference between the probability of success of an attacker with access to the model and the probability of success of the same attacker without access to the model. The advantage metric is generally normalized to a value in the range [0,1], where 0 implies no advantage and 1 implies maximal advantage. The Bayes security metric is defined as 1 minus the maximal advantage, and thus also takes values in the range [0,1], where 1 implies that the model is perfectly secure (i.e., exhibits no information leakage for this kind of attack) and smaller values indicate some leakage. For membership inference attacks, the attacker advantage and Bayes security can be computed from (ε, δ) values using existing techniques; however, conventional methods for computing (ε, δ) are computationally intensive. For attribute inference attacks, there are no existing techniques for quantifying attacker advantage and Bayes security, even given (ε, δ) values.

The approach disclosed herein allows determining the attacker advantage or, equivalently, Bayes security directly, without using (ε, δ) values. It provides a general closed-form expression for a lower bound of Bayes security, which reduces for different types of inference attacks to different more specific expressions for the lower bound of Bayes security. The expressions constitute lower bounds because they are derived under broad, guaranteeable assumptions, with conditions in practice often being more restrictive on attackers and thus resulting in higher actual levels of Bayes security. The closed-form expressions are functions of training hyperparameters, and include a value of Bayes security that approximates the true lower bound of Bayes security along with an error term. Beneficially, the error term becomes smaller for values of the hyperparameters that ensure better privacy, and therefore, the approximate lower bound of Bayes security can be used to achieve a desired target level of Bayes security.

In various embodiments, protection against membership inference attacks is provided by selecting, for the training of a machine-learning model with DP-SGD, a combination of training hyperparameters—for example, the number of training steps, the sampling rate, and the noise multiplier—that achieves (e., meets or exceeds) a target value of Bayes security within quantifiable error margins. The model creator may, for example, have access to an interactive calculator tool that computes approximate lower bounds of Bayes security for different possible choices of the hyperparameters, enabling the determination, e.g., by iterative adjustments, of a suitable combination of hyperparameter values that achieves the target Bayes security (up to an error term). Alternatively, the model creator may specify the target value of Bayes security along with values of two of the three training hyperparameters, from which the third hyperparameter value can be straightforwardly calculated. Either way, as compared with conventional methods for obtaining estimated bounds and/or values of Bayes security indirectly based on (ε, δ), the direct computation of a lower bound of Bayes security in accordance herewith can, for suitable choices of the hyperparameters, provide the same degree of accuracy (as measured in terms of the error term) at a computational cost that is significantly lower (e.g., orders of magnitudes lower as compared with some prior-art methods). As a result, the process of choosing suitable hyperparameters, which generally involves either an expansive grid search over many combinations of parameter values or a limited search relying on expert knowledge, is significantly sped up using the disclosed approach to computing Bayes security directly.

In various embodiments, protection against attribute inference attacks is achieved by training the machine-learning model with a modified DP-SGD algorithm that involves computing gradient bounds with respect to the attribute or attributes of interest during training. The gradient bounds, along with values of training hyperparameters, (such as sampling rate, noise multiplier, gradient norm clipping parameter, and number of training steps) then flow into the computation of a value of Bayes security, such as an approximate lower bound, for Bayes security updated after each training step. Based on the computed value(s) of Bayes security, a privacy-preserving action may be taken. For example, since continued training generally increases the accuracy of the trained model at the cost of decreasing security against inference attacks, model training may be stopped once the value of Bayes security falls below a specified threshold. Alternatively, the model may be trained for a specified number of steps or until a given model accuracy or other model performance has been achieved, and deployment of the trained model may then be contingent upon Bayes security exceeding a target value, or a model may be selected among multiple models trained for a given task, e.g., differing in their training hyperparameters or the datasets on which they have been trained, to maximize Bayes security. Values of the value of Bayes security computed during training may also be used to update the training hyperparameters to increase Bayes security.

From bounds for Bayes security determined using the approach discussed herein, it has been observed that DP-SGD tends to be significantly more secure against attribute inference than against membership inference attacks. Accordingly, if a practical application requires security against attribute inference rather than membership inference, the ability to quantify Bayes security against attribute inference, as achieved with the modified DP-SGD algorithm and closed-form bound discussed herein, allows achieving better utility of the trained machine-learning model while maintaining acceptable privacy. A further benefit of the disclosed approach, as applied to attribute inference, is that the computed value of Bayes security is data-dependent. Data-dependent guarantees are less conservative, and allow practitioners to choose DP-SGD hyperparameters to protect against actual, rather than merely abstract, threats.

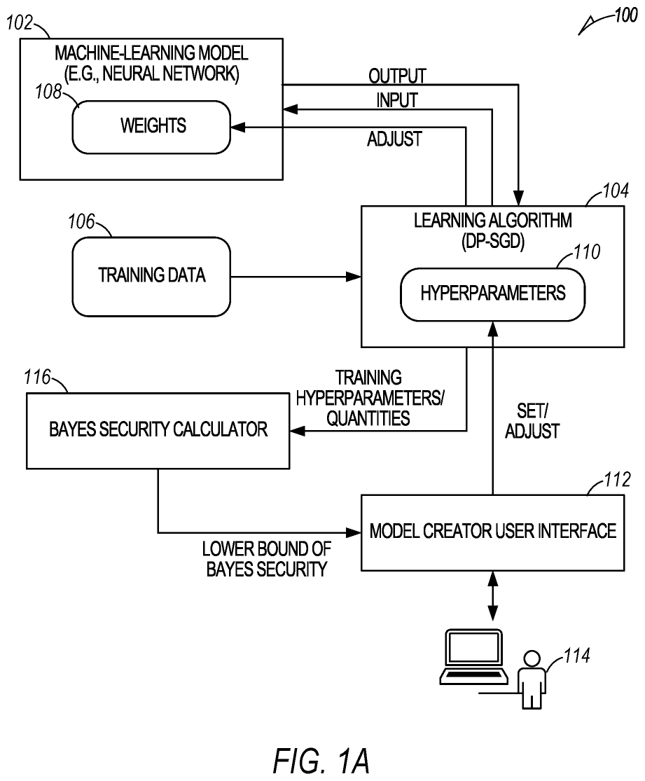

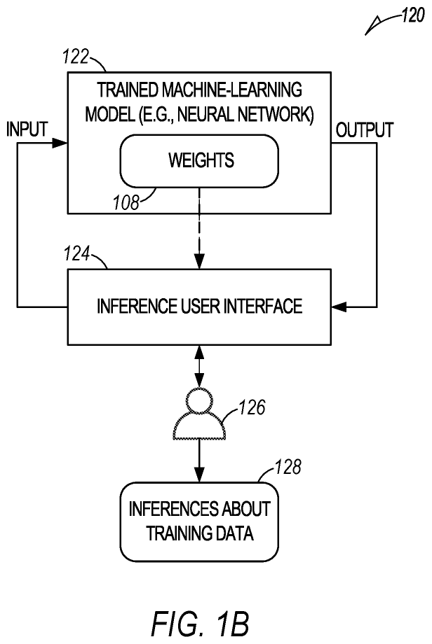

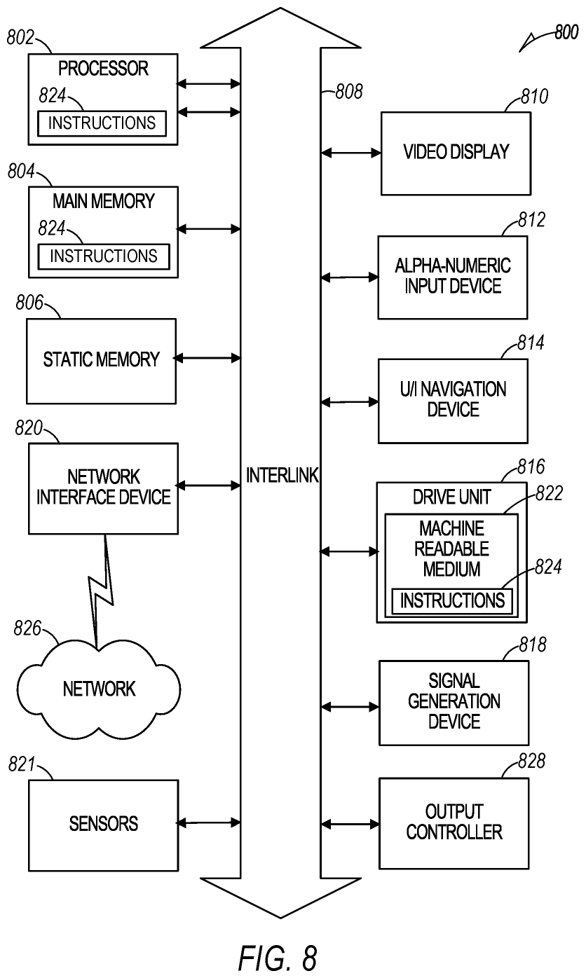

FIG. 1A is a block diagram of an example computing system 100 for the differentially private training of machine-learning models and quantification of the resulting Bayes security in accordance with various embodiments. The computing system 100 can be implemented on one or more computing machines (e.g., as described below with reference to FIG. 8) that generally include volatile and/or non-volatile computer memory storing data (depicted with rounded corners) and machine-readable instructions, e.g., organized as various programs or program modules (depicted with sharp corners), and one or more computer processors (e.g., CPUs, GPUs, or special-purpose processors) to execute the instructions.

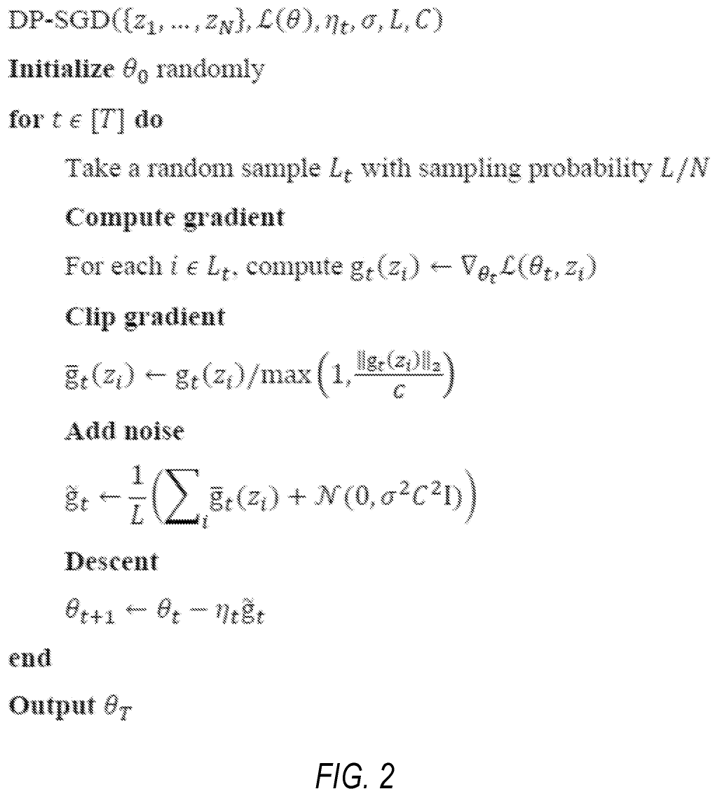

The system 100 includes the machine-learning model 102 itself, as well as a learning algorithm 104 and set of training data 106 used to train the model 102. Training involves determining the free parameters, or “weights” 108, of the model 102 so as to optimize a loss function or objective function that is defined to capture how well the model 102 fits the training data 106. For example, in supervised learning, the training data records are input-output pairs, and the weights 108 are adjusted to minimize the difference, aggregated across sampled data records, between the output computed by the model 102 from the input of a given input-output pair and the corresponding “ground-truth” output (also often referred to as the “label”) of that data pair; the loss function is some function of the aggregated differences. In unsupervised learning, where the training data is label-free, the objective function captures some task-specific measure of the goodness of the fit. For clustering tasks, for example, the weights may be optimized to minimize the variability of data points within clusters and maximize the distance between clusters. In accordance herewith, the learning algorithm 104 is a DP-SGD algorithm, explained below with respect to FIG. 2. In various embodiments, the machine-learning model 102 is or includes a neural network or set of neural networks.

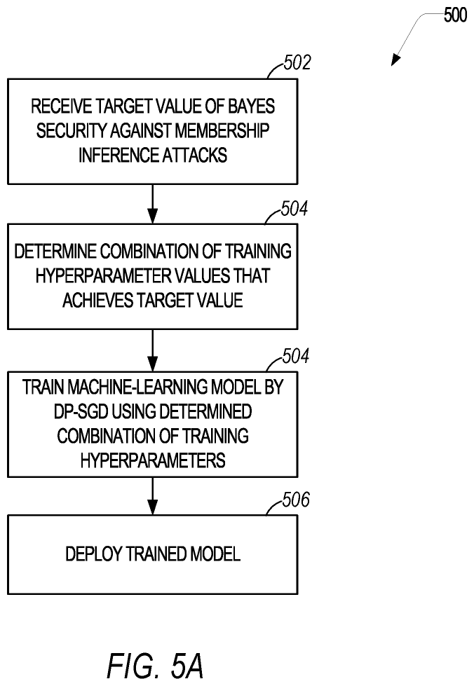

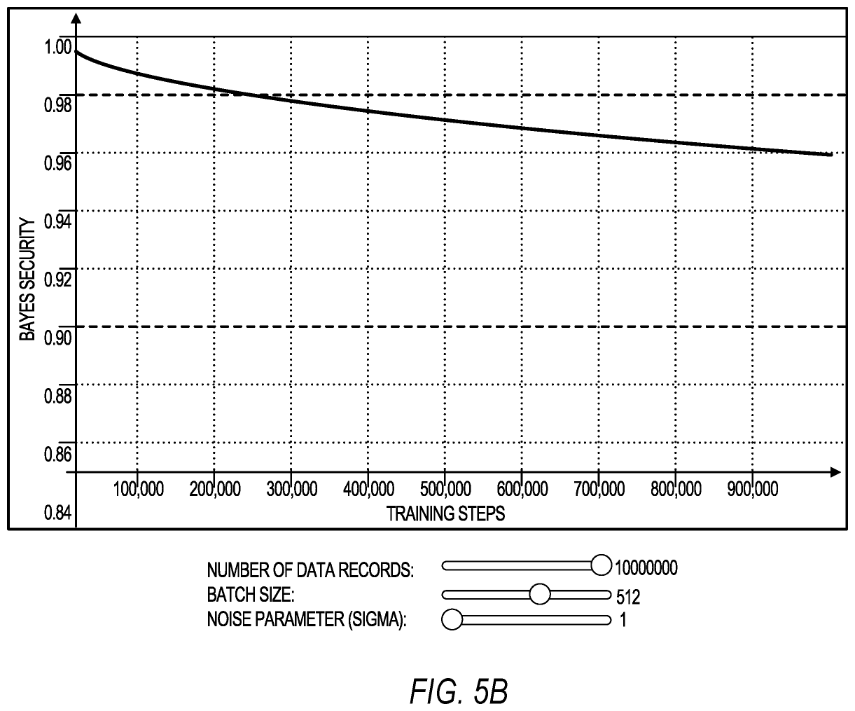

The learning algorithm 104 includes a number of training hyperparameters 110 that can be set, e.g., via a suitable model creator user interface 112, by a (human) model creator 114. These hyperparameters may include, e.g.: the number of training steps, that is, iterations in the iterative adjustment of the weights 108; the sampling rate, that is, the probability with which any given data record of the training dataset is included in the subset used in a given training step, which is equivalent to the ratio of the expected or average number of training data records used per training step (also referred to as the expected “batch size”) to the total number of data records in the training dataset; the learning rate, which determines the magnitude of weight adjustments in the training iterations; a gradient norm clipping parameter to which gradients calculated during training are scaled if their norm exceeds the parameter; parameters of the objective function (such as a regularization constant or penalty term); and in DP-SGD, a noise multiplier. Some of these parameters affect the extent to which the trained model will be vulnerable to inference attacks, and should therefore be selected carefully to optimize data privacy. To this end, the system 100 further includes a Bayes security calculator 116 that represents, for one or more types of inference attacks, relationships between Bayes security (or, more precisely, an approximate lower bound on Bayes security) and training hyperparameters along with, in some cases, other quantities computed during the training process. By accessing the Bayes security calculator 116, e.g., via the model creator user interface 112, the model creator 114 can obtain values (e.g., approximate lower bounds) for Bayes security before, during, or after training (depending on the specific embodiment) and, based thereon, take or cause appropriate privacy-preserving actions, as explained in detail below with reference to FIGS. 5-7.

FIG. 1B is a block diagram of an example computing system 120 deploying a trained machine-learning model 122, such as results from training the model 102 in the system 100 of FIG. 1A. The system 120 includes, in addition to the machine-learning model 122 itself, an inference user interface 124 through which a user 126 can interact with the model 122, feeding it input and receiving the model-generated output. The system 120 can be implemented on one or more computing machines, and may overlap with the system 100 used to create and train the model 122. That is, in some embodiments, the machine-learning model 102/122, once training is complete, can be directly accessed on the same computing machine as was used for training, e.g., through the inference interface 124, which may likewise run on the same machine, or on a separate machine that communicates with the machine storing the trained model 102/122 via a suitable local or remote wired or wireless network connection (e.g., via the Internet or a local area network (LAN)). In alternative embodiments, the deployed model 122 is a copy of the trained model 102 that is stored and operated within a computing system 120 separate from the system used for training 100. Either way, the user 126 may have the ability, by obtaining model outputs for various carefully selected inputs, and optionally by directly accessing the model weights 108, to draw inferences 128 about the training data 106. The use of a DP-SGD (as opposed to conventional SGD) algorithm to train the data serves to limit the scope of such inferences and preserve data privacy as much as possible.

FIG. 2 is pseudocode illustrating an example DP-SGD algorithm. Compared with a conventional SGD algorithm, the DP-SGD algorithm achieves differential privacy—that is, privacy for individual data records that does not undermine the extraction of patterns and statistics of the dataset at large—by introducing noise into the computation of the gradients used to update the model weights. In general, the greater the noise, the more resilient the model will be to inference attacks. This gain in privacy, however, comes at the cost of reduced model accuracy. The DP-SGD algorithm operates on a set of training data records {z₁, . . . , z_{N}}∈ [symbol] ^{N} and a loss function

$$ℒ ( θ ) = \frac{1}{N} {\sum }_{i} ℒ ( θ , {z}_{i} )$$

that is based on model weights θ, and its hyperparameters include learning rates ηₜ, a noise multiplier σ, a gradient norm clipping parameter C, an expected batch size L, and a number of training steps T. The DP-SGD algorithm trains the model as follows: for each training step t=0, . . . , T−1, on average L records are sampled from the training dataset, the gradients of the loss function [symbol] (θₜ, zᵢ) with respect to the current model weights θₜ are computed, the per-sample gradient norms are clipped to C, isotropic Gaussian noise with standard deviation σC is added to the sum of the clipped gradient norms, and the resulting sum \tilde{g}ₜ scaled by 1/L is used to update the model weights θₜ according to the learning rate ηₜ, obtaining the new model weights θₜ₊₁.

Training a model with DP-SGD facilitates providing privacy guarantees in terms of upper bounds on the privacy parameters (ε, δ). The parameters relate to the probability that an attacker can distinguish between two neighboring training datasets (e.g., datasets differing in only one data record) based on the output of the learning algorithm, namely, the model weights (including intermediate weights during training). At an intuitive level, ε measures the amount of information leaked by the output of the learning algorithm, and δ measures the probability of a privacy failure in the sense that the learning algorithm produces an output that leaks information in excess of ε. Values of (ε, δ) can be determined with an “accounting” mechanism that tracks the privacy cost associated with each access to the training data, accumulated over the course of model training. Accounting mechanisms, however, are not only computationally expensive, but also tend to be error-prone, e.g., due to implementation difficulties or numerical errors. In addition, the privacy parameters (ε, δ) are generally threat-agnostic, but in practice, there are cases where certain types of threats give rise to privacy concerns while others do not. For example, the fact that a person participated in the census dataset is not privacy-sensitive per se, but if an attacker were able to infer the values of sensitive attributes such as race or age, that would be a privacy violation. There appears no principled way to render (ε, δ) values interpretable without considering specific threats. While prior efforts have been directed at linking (ε, δ) values to threat-specific privacy metrics, the approach discussed herein evaluates machine-learning models directly against the risk of certain record-level inference attacks, in particular membership and attribute inference attacks.

In various embodiments, the risk of specific types of inference attacks is measured in terms of Bayes security, which in turn is based on the notion of attacker advantage. The metric of attacker advantage quantifies how much more likely an attacker is to succeed when given access to the trained model, as compared with not having this access. To formally define attacker advantage, suppose the attacker's goal is to guess some secret information, measured by a random variable S, and the attacker has some prior knowledge about S, mathematically captured in a probability distribution It over the range (meaning, all possible values) of S. For example, in a membership inference attack, the attacker may know that the model was trained on a dataset D in conjunction with an individual data record, termed “challenge point,” Z*_{S} sampled from a set of challenge points {Z*ᵢ}ᵢ₌₁^{M} according to a prior distribution π on this set, and the attacker's goal is to guess which of the challenge points was used for training the model; in this case, the random variable S corresponds to the index (between 1 and M) of the challenge point. In an attribute inference attack, the attacker may know that a model was trained on a dataset D in conjunction with a challenge point z* that can be represented as the concatenation of two vectors φ and s, where s corresponds to one or more sensitive attributes s∈ [symbol] of the data record sampled according to a prior distribution π, and the attacker's goal is to infer the value(s) of s given access to the remainder φ of the data record; in this case, the random variable corresponds to the attribute(s) s. Both cases can be unified in a more general framework for record-level property inference attacks, in which the attacker aims to infer some property f(z*) about some data record z* (the challenge point), with f(z*) being, for membership inference, an index to the set of challenge points such that z*=z*_{f(z*)}, and for attribute inference, f(z*)=s. The function f(z*) may be a bijection, meaning that there is exactly one challenge point z*=f⁻¹(s) for each property value s∈dom(f⁻¹).

We assume that an attacker with access to the model weights θ (in addition to the prior π), herein indicated as Attacker(π,θ), will be at least as successful in guessing S as an attacker without access to the model weights θ, who guesses purely based on the prior π. The “generalized advantage,” Adv_{π}, is defined as the difference between the probabilities of success of these two attackers, normalized to a value between 0 and 1 (wherein 0 implies no advantage and 1 implies maximum advantage):

$${Adv}_{π} = \frac{Pr [ Attacker ( π , θ ) = S ] - Pr [ Attacker ( π ) = S ]}{1 - Pr [ Attacker ( π ) = S ]}$$

Bayes security, β*, is defined as the complement of the maximum attacker advantage over all priors π:

$${β}^{*} = 1 - {max}_{π} {Adv}_{π}$$

It can be shown that the generalized advantage is maximized, and Bayes security is achieved, on a uniform prior distribution over two secrets s₀, s₁∈ [symbol] (where [symbol] is the set of challenge points (or their indices) in case of a membership inference attack and the set [symbol] of attribute values in case of an attribute inference attack):

$${β}^{*} = 1 - {max}_{{s}_{0} , {s}_{1} ϵ𝕊} {Adv}_{u ( {s}_{0} , {s}_{1} )} ,$$

where [symbol] (s₀, s₁) is the uniform prior, meaning that Pr[S=s₀]=Pr[S=s₁]=½ and Pr[S=s]=0 for all s≠s₀, s₁. Consequently, when studying the security of DP-SGD, it is sufficient to limit the range of S to the two values that are the easiest to distinguish for the attacker, and set It to the uniform prior. For example, for membership inference, this means that by measuring the security for just two challenge points (M=2) that are equally likely to be members, a bound on Bayes security is obtained for arbitrary values of M≥2. Similarly, for attribute inference, it is sufficient to look at the two leakiest attribute values.

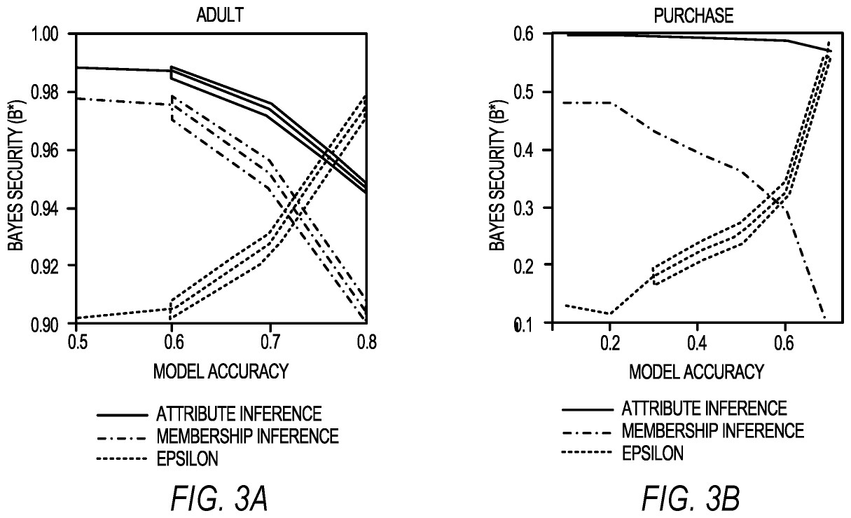

FIGS. 3A and 3B are graphs, determined using example datasets, of Bayes security against membership inference attacks and attribute inference attacks as a function of trained model accuracy. FIG. 3A is based on the Adult dataset, which contains census data for over thirty thousand individuals, with attributes such as age, education, and income. FIG. 3B is based on the Purchases dataset, which contains transaction data of five thousand customers with binary attributes, such as whether or not they bought a certain product. Both datasets are publicly available and commonly used in differential privacy testing. In addition to Bayes security for the two specific types of record-level inference attacks, FIGS. 3A and 3B also illustrate (ε, δ) privacy parameters (dashed lines) with ε values for δ=3.8×10⁻⁶ (FIG. 3A) and δ=4×10⁻⁷ (FIG. 3B). As can be seen, Bayes security decreases and privacy loss increases with higher model accuracy, presenting a trade-off. In DP-SGD, the model accuracy will generally increase as training continues, at the cost of decreasing privacy; conversely, the privacy can be improved by introducing greater noise in the computation of gradients, at the cost of reduced model accuracy for a given number of training iterations. Accordingly, the number of training steps and amount of noise are examples of training hyperparameters that can be selected with a view towards optimizing the tradeoff between privacy and model accuracy. Such optimization is aided by establishing guaranteed bounds on privacy, e.g., as measured in terms of Bayes security, dependent on the training hyperparameters.

Provided herein are lower bounds on Bayes security of DP-SGD against record-level property inference attacks. It is assumed that the attacker aims to guess the random secret property S given not only the model weights following completion of training, but also all intermediate model weights, collectively θ=(θ₀, θ₁, . . . , θ_{T}), for T time steps in model training. While this assumption will rarely be met in practice, where the attacker will generally have access to only the final model weights (if that), it does not undermine providing a security guarantee since less information available to the attacker would only raise the level of security, and accordingly, a bound on Bayes security derived from the larger set including intermediate model weights is still a valid lower bound. The model weights θ=(θ₀, θ₁, . . . , θ_{T}) that the attacker observes are sampled from a random model weights vector O=(O₀, O₁, . . . , O_{T}), which is conditioned on S because the secret property corresponds to a data record, or attribute thereof, used as part of the training data. The relation between S and O is ruled by the posterior distribution P_{O|S}, which can be viewed as an information theoretic channel. The Bayes security of this channel, β*(P_{O|S}), measures the additional leakage about the secret S that the attacker can exploit by observing O.

As it tuns out, the attacker obtains an even greater advantage if given direct access to the intermediate gradients computed in updating the model weights, rather than the model weights themselves, because the gradients carry at least as much information about the challenge point z* as O. In other words, an attacker has a better advantage (or at least equal) advantage when attacking the channel P_{G|S}, where G=(G₀, . . . , G_{T-1}) is the random gradient vector, than when attacking channel P_{O|S}. While access to the intermediate gradients is even less likely to be available in practice than access to the intermediate weights, once again, lowering the lower bound as a result of assuming access to the gradients preserves the security guarantee:

$${β}^{*} ( {P}_{O \vert S} ) \geq {β}^{*} ( {P}_{G \vert S} )$$

Combining this insight with the above-noted fact that Bayes security is achieved on a uniform prior distribution over two secrets s₀, s₁, Bayes security can be bounded by:

$${β}^{*} ( {P}_{O \vert S} ) \geq {β}^{*} ( {P}_{G \vert S} ) \geq 1 - {max}_{{s}_{0} , {s}_{1}} tv ( {P}_{G \vert S = {s}_{0}} , {P}_{G \vert S = {s}_{1}} ) ,$$

where tv denotes the total variation distance, as the term is understood in the art. In words, Bayes security of DP-SGD can be computed as the maximal total variation between the two posterior distributions P_{G|S=s}_{₀} and P_{G|S=s}_{₁} across all pairs s₀, s₁∈ [symbol] .

In the above expression for Bayes security, P_{G|S} is a mixture of Gaussians. This mixture distribution can be approximated by a single Gaussian distribution for certain choices of parameters that cover many practical purposes (see, e.g., the below example). With this approximation, Bayes security of DP-SGD with respect to a record-level inference threat becomes:

$${β}^{*} ( {P}_{O \vert S} ) \geq 1 - erf ( p \frac{{Δ}_{f}}{2 \sqrt{2} σ C} ) - O ( \frac{\sqrt{pT}}{σ} )$$

Herein, erf denotes the Gauss error function, and 1−erf(p·Δ_{f}/(2√2̅σC)) is an approximate lower bound on Bayes security, with O ( . . . ) being an approximation error term in asymptotic notation; the approximation error becomes negligible for training hyperparameters that ensure good privacy. Further, f is a bijection and denotes the property of interest, and Δ_{f} is a threat-model-dependent variable computed from the gradients at the challenge point:

$${Δ}_{f} = {max}_{{s}_{0} , {s}_{1} ∈ dom ( {f}^{- 1} )} ‖ \overline{g} ( {f}^{- 1} ( {s}_{0} ) ) - \overline{g} ( {f}^{- 1} ( {s}_{1} ) ) ‖ ,$$

where g̅(z*)=(g̅₀(z*), . . . , g̅_{T-1}(z*)) is the sequence of gradients computed by DP-SGD on a challenge point z*, f⁻¹(s) is the challenge point that satisfies f(f⁻¹(s))=s, and ||·|| is the Frobenius norm. Intuitively, Δ_{f} indicates how much influence each property value has on the gradients, and takes higher values the more the gradient change when the property value changes; in particular, it captures the worst-case scenario, when the attacker has to distinguish between the two property values that leak the most information.

In one example application, a language model was trained using DP-SGD with a training dataset of N=250000 training samples, a batch size of L=256 samples, a noise multiplier σ=0.8, a number of training steps T=3000, and a gradient norm clipping parameter C=0.1. These choices of hyperparameters resulted in a DP guarantee of ε=2.09 for δ=1/N. The direct computation of Bayes security against membership inference using the above equation resulted in an approximate lower bound of 0.944, which is within 1% relative error of a bound of 0.933 computed indirectly through (ε, δ).

The above general result for the lower boundary of Bayes security against record- level inference attacks will now be applied to specific attack types, in accordance with various embodiments.

### Membership Inference

In membership inference attacks, f(z*ₛ)=s, and Δ_{f} is bounded as follows:

$${Δ}_{f} = {max}_{{z}_{0}^{*} , {z}_{1}^{*} ∈ dom ( f )} ‖ \overline{g} ( {z}_{0}^{*} ) - \overline{g} ( {z}_{1}^{*} ) ‖ \leq 2 C \sqrt{T} ,$$

such that the lower bound of Bayes security reduces to:

$${β}^{*} \geq 1 - erf ( p \frac{\sqrt{T}}{\sqrt{2} σ} ) - O ( \frac{\sqrt{pT}}{σ} ) .$$

This expression facilitates straightforwardly calculating Bayes security from the number of training steps T, the sampling rate p, and the noise multiplier σ, or conversely, to determine, for a given target Bayes security, a suitable combination of these training hyperparameters. (Note that the sampling rate p may be specified indirectly in terms of the expected number of samples L per training step and the total number of samples N, which is functionally equivalent to specifying p. Similarly, there may be other parameters or expressions that are equivalent to p, T, or σ. Reference to the number of training steps, the sampling rate, and/or the noise multiplier in this specification is deemed to encompass their functional equivalents in scope.)

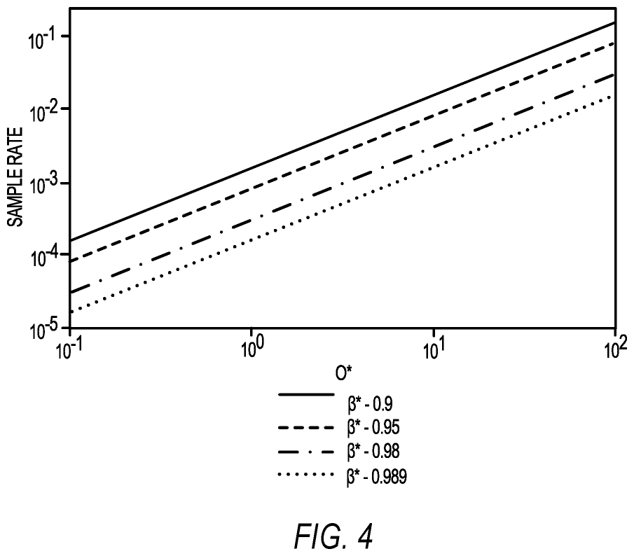

FIG. 4 is an example graph illustrating the selection of a combinations of sampling rate and noise to achieve a desired level of Bayes security at a given number of training steps, in accordance with one embodiment. In this example, the model is to be trained for T=5000 training steps. Suppose that a Bayes security of β*≥0.98 is desired for an application; with a uniform membership prior (meaning an assumption that 50% of data records that the attacker has are members of the training data, or if the attacker has only one record, that the record is a member of the training data with 50% probability), this security level correspond to at most a 51% attack success probability. The desired level of protection can then be achieved by choosing p and σ according to the relation:

$$p = \frac{{erf}^{- 1} ( 1 - {β}^{*} ) \sqrt{2}}{\sqrt{T}} σ ,$$

in this example p≈0.000350 (depicted as a dash-dotted line). Any combination of values of p and σ meeting this linear relation will achieve the desired value of Bayes security (up to an error on the order of √p̅T̅/σ).

FIG. 5A is a flowchart of an example machine-learning method 500 for protecting against membership inference attacks, in accordance with one embodiment. The method 500 may be implemented using, for instance, the computing systems 100, 120 of FIGS. 1A and 1B. The method 500 involves receiving, e.g., via a model creator user interface 112, a target value of Bayes security against membership inference attacks for a machine-learning model (502). A combination of training hyperparameters that achieves, e.g., meets or exceeds, within an error margin, the target value of Bayes security is then determined (504), e.g., by a software tool such as the Bayes security calculator 116, based on the above-stated lower bound of Bayes security as a function of the training hyperparameters T, p, and σ. In some embodiments, this determination involves specifying two of the three training hyperparameters to calculate the third. In some embodiments, the training hyperparameters are determined iteratively, starting from initial values, by computing in each iteration the value (corresponding to an approximate lower bound) of Bayes security that would result from the current combination of hyperparameter values, and if the computed lower bound falls below the target value, adjusting one or more of the parameters with a view towards increasing the value of Bayes security, and continuing the process until the target value is reached. In this iterative process, the target value need not necessarily be provided explicitly to the computing system 100; instead, the model creator 114 may tweak the hyperparameters (or a subset of hyperparameters) based on a resulting value of Bayes security, e.g., as output in the model creator user interface 112, until he is satisfied with the achieved level of security. Once a suitable combination of values of the training hyperparameters has been determined, the machine-learning model is trained by DP-SGD with these training hyperparameter values (506). The trained model can subsequently be deployed (508), e.g., using computing system 120, with a level of privacy protection that is guaranteed to be or exceed the specified target Bayes security.

FIG. 5B is an example screen layout of a software tool for adjusting training hyperparameters to achieve a desired level of Bayes security against membership inference attacks, in accordance with one embodiment. This software tool may integrate the functionality of the Bayes security calculator 116 with the model creator user interface 112. As can be seen, a number of user interface elements, such as sliders, allow the model creator to specify the number of data records available in the training dataset, the batch size (or, alternatively, the sampling rate, which is the ratio of the batch size to the number of data records in the training dataset), and the noise multiplier. From these training hyperparameters, the tool then computes and graphs the approximate lower bound of Bayes security as a function of the number of training steps. The model creator may modify the hyperparameter values until a desired level of Bayes security at an acceptable number of training steps is achieved.

Bayes security against membership inference serves to protect the existence of a particular data record in the training dataset from discovery, which is important when the mere inclusion in the training data reveals sensitive information. Consider, for example, a machine-learning model trained on patient data of people having a certain disease (e.g., HIV); if an attacker discovers that a particular person's data was used in training the model, the attacker can then infer that that person has HIV. As another example, consider a model trained on financial records based on various data sources; in this case, an attacker (e.g., acting on behalf of a competitor of a trading institution) who can infer which sources the trading institution used in training the model may be able to make certain stock market predictions based thereon. Other usage scenarios and applications will occur to those of ordinary skill in the art.

### Attribute Inference

In attribute inference attacks, assuming that for every challenge point z* there is exactly one value s∈ [symbol] such that f(z*)=s, and denoting the non-sensitive part of z* as φ(z*), the lower bound of Bayes security becomes:

$${β}^{*} \geq 1 - erf ( p \frac{‖ R ‖}{2 \sqrt{2} σ C} ) - O ( \frac{\sqrt{pT}}{σ} ) ,$$

where R=(R₀, . . . , R_{T-1}) with:

$${R}_{t} = {max}_{{z}^{*} ∈ {L}_{t}} {max}_{{s}_{0} , {s}_{1} ∈} ‖ {\overline{g}}_{t} ( φ ( {z}^{*} \vert {s}_{0} ) ) - {\overline{g}}_{t} ( φ ( {z}^{*} \vert {s}_{0} ) ) ‖ ,$$

where Lₜ is the batch sampled at step t. In this case, as can be seen, the lower bound on Bayes security depends not only on the training hyperparameters, which here include the gradient norm clipping parameter C in addition to T, p, and σ, but also the gradients computed during model training. The bound on Bayes security is, thus, data-dependent: the value of Rₜ at any time step t depends on the model weights θₜ at that step as well as on the data itself.

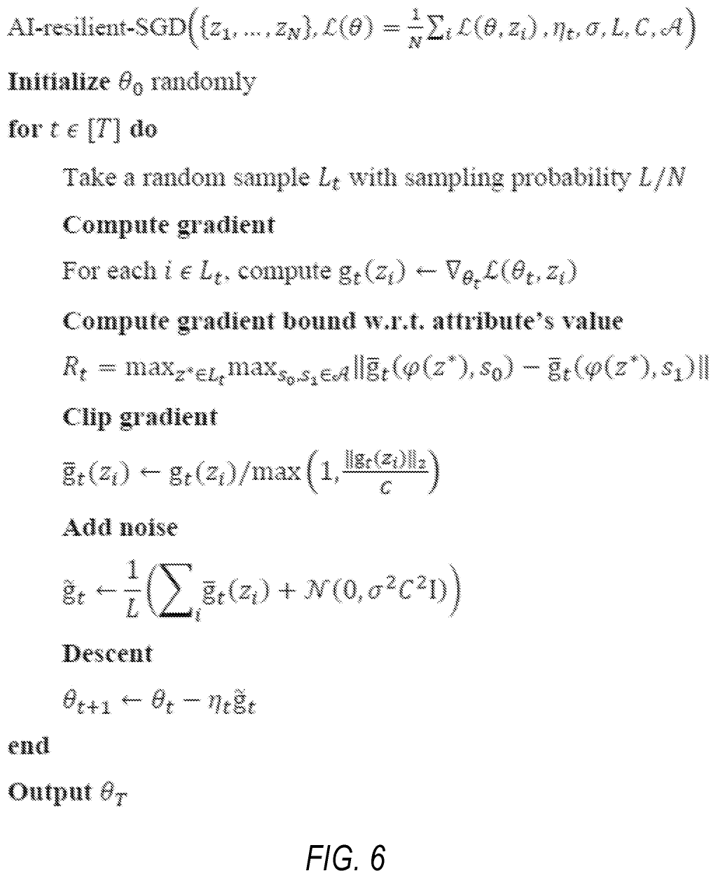

FIG. 6 is pseudocode illustrating a modified DP-SGD algorithm for quantifying Bayes security against attribute inference attacks, in accordance with one embodiment. The algorithm is specific to an attribute of interest, or set of attributes of interest, with value range [symbol] . It differs from the conventional DP-SGD algorithm of FIG. 2 in that, for each batch Lₜ, following the computation of gradients, a gradient bound is computed by augmenting φ(z*) with all completions s∈ [symbol] A for every point z*∈Lₜ, and determining the maximum distance across all pairs of challenge points z*₀=f⁻¹(s₀) and z*₁=f⁻¹(s₁). Thereafter, the gradients are clipped, noise is added, and the updated model weights are computed in the usual manner. The computed gradient bounds at each training step can be used to compute the lower bound of Bayes security resulting for that step.

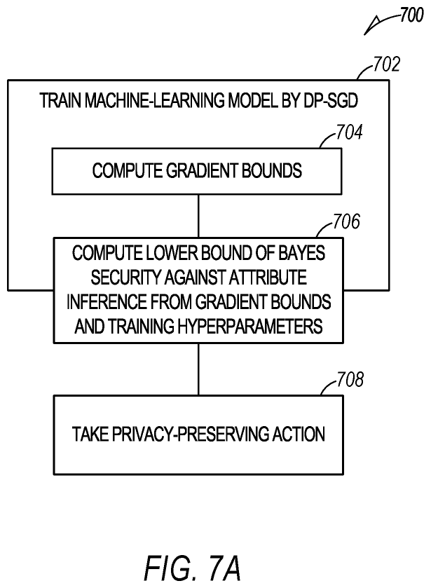

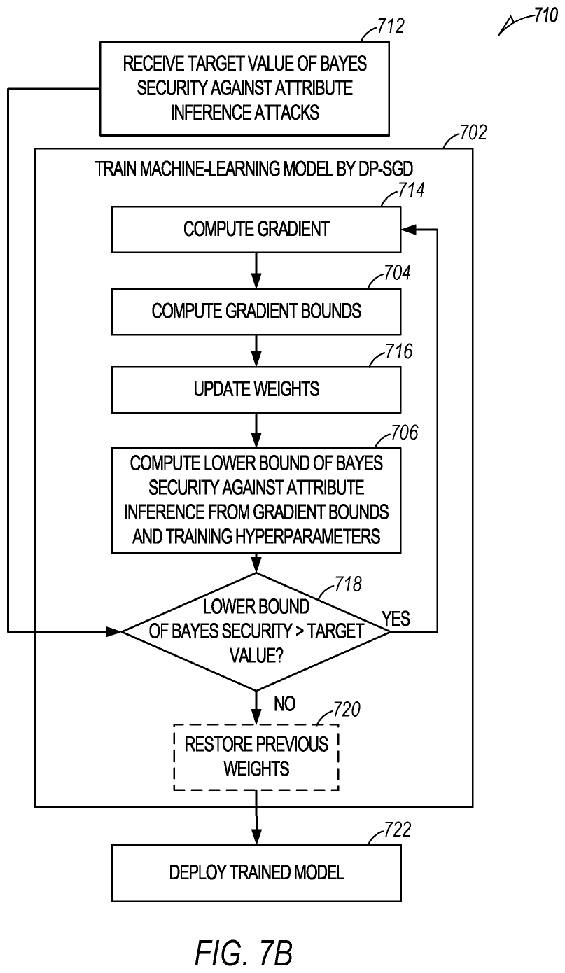

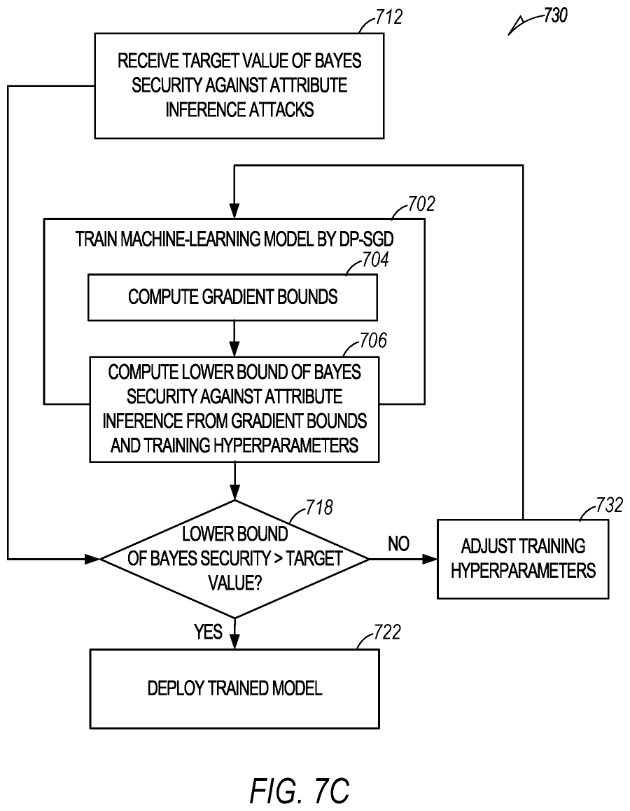

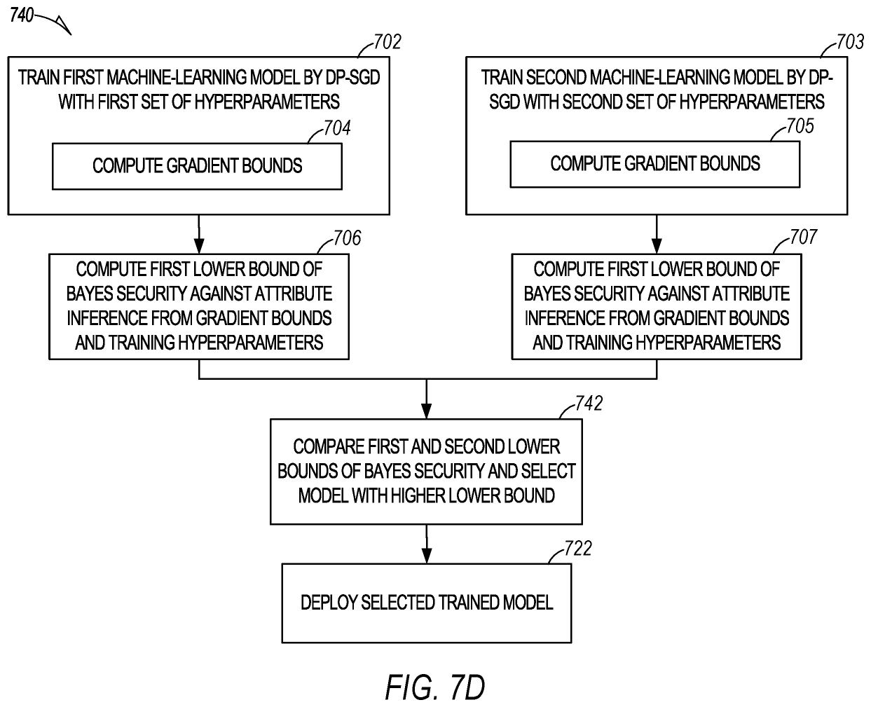

FIGS. 7A-7D are flowcharts of example machine-learning methods for protecting against attribute inference attacks, in accordance with various embodiment. These methods may be implemented using, for instance, the computing systems 100, 120 of FIGS. 1A and 1B. At a general level, illustrated in FIG. 7A, the methods 700 involve training a machine-learning model with a differentially-private stochastic gradient descent (DP-SGD) algorithm on training data records comprising an attribute (702), and computing gradient bounds with respect to values of the attribute of interest during the training iterations in accordance with the above expressions for Rₜ (704). From the computed gradient bounds, in conjunction with the values of the training hyperparameters, a value, corresponding to an approximate lower bound, of Bayes security against attribute inference is then computed during and/or after training (e.g., repeatedly after each training step, or after a specified number of training steps) (706). Based on the computed value(s) of Bayes security, some privacy-preserving action is taken (708). FIGS. 7B-7D provide examples of such privacy-preserving actions in the context of more specific embodiments.

In the example method 710 illustrated in FIG. 7B, a target value of Bayes security against attribute inference attacks is received, e.g., at the model creator user interface 112, and at multiple times during training (e.g., during each training step), following computation of gradients and gradient bounds (714, 704) and updating of the model weights (716), a new value (approximate lower bound) of Bayes security is computed (706). The computed value of Bayes security is then compared against the target value of Bayes security (718). As long as the computed value exceeds the target value of Bayes security, the iterative training process continues, generally resulting in a successive improvement in the accuracy of the machine- learning model and an incidental loss in privacy. Once the computed value of Bayes security falls below the target value, the training process is stopped—this constitutes one example of a privacy-preserving action. Optionally, the intermediate model weights may be stored over the training process, or at least over one or more past iterations, allowing a previous set of model weights that still achieved the target level of Bayes security to be restored (720) after training is stopped. Alternatively, in a slight modification of method 710, the value of Bayes security computed at the end of a training step may be compared against a threshold valued that adds a specified margin to the target value, such that, when the computed value of Bayes security first falls below the threshold value, it is likely still above the target value of Bayes security. The trained machine-learning model meeting the desired Bayes security can then be deployed (722).

The example method 730 of FIG. 7C, like the method 710 of FIG. 7B, involves receiving a target value of Bayes security against attribute inference attacks (712), and comparing a value (approximate lower bound) of Bayes security determined from the gradient bounds computed during training against the target value (718). In this case, if the target value is not achieved, the values of the training hyperparameters are adjusted to improve Bayes security (732), constituting the privacy-preserving action in this case. For example, the noise multiplier may be increased, or the sampling rate decreased. In one embodiment, the comparison of the computed value of Bayes security against the target value is performed after the model has been trained for the desired number of steps, and if the training hyperparameters are adjusted, the training process starts over with the new training hyperparameter values; otherwise, if the target value is met, the trained model is deployed as is (722). In another embodiment, the comparison of the computed value of Bayes security against the target value (718) is repeated multiple times during the training process (e.g., after each training step), and following any adjustments of the training hyperparameters (732), training simply resumes with the new parameter values. Once training is complete, e.g., once a specified number of training steps have been performed, and provided the value of Bayes security is above the target value at that point, the model may be deployed (722).

In the example method 740 of FIG. 7D, multiple machine-learning models (e.g., as depicted, two models) are trained by DP-SGD (702, 703), differing in the model structure itself and/or in the hyperparameters of the DP-SGD algorithm, and from gradient bounds computed during training (704, 705) in conjunction with the values of the training hyperparameters, respective values (corresponding to approximate lower bounds) of Bayes security are determined for the various models (706, 707). The values of Bayes security are then compared, and the model that provides the greatest level of privacy protection, that is, the model with the highest value of Bayes security, is selected (742) for deployment. In this embodiment, the privacy-preserving action consists of the selection of the most secure among multiple trained models.

In yet another example, a machine-learning model may be trained by DP-SGD and the resulting value of Bayes security computed, and comparison against a specified target value of Bayes security may be used to simply make a binary decision whether or not to deploy the trained model. The privacy-preserving action amounts, in this case, to a simple check for sufficient security.

The above-described methods for protecting against attribute inference attacks can be combined and modified in various ways, as will be apparent to those of ordinary skill in the art given the benefit of this disclosure.

Protecting against attribute inference is often important in connection with machine- learning models trained on people's personal data, such as, e.g., medical records or financial records. Such data may include general or domain-specific demographic attributes, such as, for example and without limitation: age, gender, race, ethnicity, national origin, marital status, education level, employment status, diseases, drug dosages, earnings, credit ratings, etc. Another type of application involves data records that are images or text, where an attacker may infer patches of the image given the remainder of the image, or portions of the text given the remainder of the text. Various applications and uses of measuring Bayes security as described herein to achieve a desired level of security against attribute inference attacks will occur to those of ordinary skill in the art.

FIG. 8 is a block diagram of an example computing machine that may be configured to perform the computational methods described herein. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a smartphone, a web appliance, a network router, switch or bridge, a server computer, a database, conference room equipment, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. In various embodiments, machine(s) 800 may implement the computing systems 100, 120 of FIGS. 1A and 1B, and may perform one or more of the processes described above with respect to FIGS. 2, 5, 6, and 7A-7D.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine-readable medium 822 on which are stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine-readable media.

While the machine-readable medium 822 is illustrated as a single medium, the term “machine-readable medium” may include a single medium or multiple media (e.g., a centralized or distributed database, and/or associated caches and servers) configured to store the one or more instructions 824.

The term “machine-readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine-readable media may include non-transitory machine readable media. In some examples, machine-readable media may include machine-readable media that are not a transitory propagating signal.

The instructions 824 may further be transmitted or received over a communications network 826 using a transmission medium via the network interface device 820. The machine 800 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The following numbered examples are illustrative embodiments:

Example 1 is a machine-learning method for protecting against attribute inference attacks is provided. The method includes training a machine-learning model with a DP-SGD algorithm on training data records comprising at least one attribute; computing gradient bounds with respect to values of the at least one attribute during training; computing a value of Bayes security against record-level inference of the at least one attribute from the gradient bounds in conjunction with values of a set of training hyperparameters of the DP-SGD algorithm; and taking a privacy-preserving action based on the value of Bayes security.

Example 2 is the method of example 1, wherein the privacy-preserving action comprises updating the values of the set of training hyperparameters to increase the value of Bayes security.

Example 3 is the method of example 1, wherein the value of Bayes security is repeatedly updated during training, and the privacy-preserving action comprises stopping training the machine-learning model once the value of Bayes security falls below a target value.

Example 4 is the method of example 3, wherein training the machine-learning model includes iteratively updating weights of the machine-learning model, the weights being stored over the course of multiple successive iterations, and wherein the privacy-preserving action further comprises, once the value of Bayes security falls below the target value, restoring the weights of the machine-learning model associated with an earlier iteration of the multiple successive iterations.

Example 5 is the method of example 1, wherein the privacy-preserving action includes, upon completing training the machine-learning model, comparing the value of Bayes security against a target value, and deploying the machine-learning model only if the lower bound of Bayes security meets or exceeds the target value.

Example 6 is the method of example 1, further comprising training at least one alternative machine-learning model on the training data records by DP-SGD with an associated set of training hyperparameters, computing values of Bayes security against record-level inference of the attribute for the at least one alternative machine-learning model from gradient bounds with respect to values of the attribute computed during training of the at least one alternative machine-learning model in conjunction with values of the associated set of training hyperparameters; and upon completion of training the machine-learning model and the at least one alternative machine-learning model, selecting, among the machine-learning model and the at least one alternative machine-learning model, a model that has a highest associated final value of Bayes security for deployment.

Example 7 is the method of any of examples 1-6, wherein the set of training hyperparameters includes: a sampling rate, a noise multiplier, and a gradient norm clipping parameter.

Example 8 is the method of example 7, wherein the set of training hyperparameters further includes a number of training steps.

Example 9 is the method of example 7 or example 8, wherein the value of Bayes security is computed using a Gauss error function of an argument that comprises a combination of a norm of the gradient bounds computed during the training, the sampling rate, the noise parameter, and the gradient norm clipping parameter.

Example 10 is the method of any of examples 1-9, wherein the data records are personal records for a plurality of people and the attributes comprise a demographic attribute.

Example 11 is the method of example 10, wherein the data records are one of medical records for a plurality of patients or financial records for a plurality of people.

Example 12 is one or more machine-readable media storing processor-readable instructions that, when executed by one or more computer processors, cause the one or more computer processors to perform operations implementing any of the methods of examples 1-12.

Example 13 is a system including one or more computer processors and one or more machine-readable media storing processor-readable instructions that, when executed by one or more computer processors, cause the one or more computer processors to perform operations implementing any of the methods of examples 1-12.

Example 14 is a machine-learning method for protecting against membership inference attacks. The method includes receiving a target value of Bayes security against membership inference attacks; determining a combination of values of a set of training hyperparameters that achieves the target value of Bayes security, the set of training hyperparameters comprising: a number of training steps, a sampling rate, and a noise multiplier;

and training the machine-learning model on a training dataset, using a DP-SGD learning algorithm and the computed combination of values of the set of training hyperparameters.

Example 15 is the method of example 14, wherein the trained machine-learning model is deployed to infer outputs from inputs provided to the trained machine-learning model.

Example 16 is the method of example 14, wherein determining the combination of values of the set of training hyperparameters comprises fixing values of two hyperparameters selected among the number of training steps, the sampling rate, and the noise multiplier and computing a value of the third hyperparameter from the fixed values of the two selected hyperparameters and the target value of Bayes security.

Example 17 is the method of example 14, wherein the values of the sampling rate, the number of training steps, and the noise multiplier are chosen such that a value of the Gauss error function of a product of powers of the sampling rate, the number of training steps, and the noise multiplier is greater than one minus the target value of Bayes security.

Example 18 is one or more machine-readable media storing processor-readable instructions that, when executed by one or more computer processors, cause the one or more computer processors to perform operations implementing any of the methods of examples 14-17.

Example 19 is a system including one or more computer processors and one or more machine-readable media storing processor-readable instructions that, when executed by one or more computer processors, cause the one or more computer processors to perform operations implementing any of the methods of examples 14-17.

Although embodiments have been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This description, therefore, is not to be taken in a limiting sense, and the scope of various embodiments is defined only by the appended claims, along with the full range of equivalents to which such claims are entitled.

What is claimed is:

1. A machine-learning method for protecting against attribute inference attacks, the method comprising:
training a machine-learning model with a differentially-private stochastic gradient descent (DP-SGD) algorithm on training data records comprising at least one attribute;
computing gradient bounds with respect to values of the at least one attribute during training;
computing a value of Bayes security against record-level inference of the at least one attribute from the gradient bounds in conjunction with values of a set of training hyperparameters of the DP-SGD algorithm; and
taking a privacy-preserving action based on the value of Bayes security.

2. The method of claim 1, wherein the privacy-preserving action comprises updating the values of the set of training hyperparameters to increase the value of Bayes security.

3. The method of claim 1, wherein the value of Bayes security is repeatedly updated during training, and wherein the privacy-preserving action comprises stopping training the machine- learning model once the value of Bayes security falls below a target value.

4. The method of claim 3, wherein training the machine-learning model comprises iteratively updating weights of the machine-learning model, the weights being stored over the course of multiple successive iterations, wherein the privacy-preserving action further comprises, once the value of Bayes security falls below the target value, restoring the weights of the machine-learning model associated with an earlier iteration of the multiple successive iterations.

5. The method of claim 1, wherein the privacy-preserving action comprises, upon completing training the machine-learning model, comparing the value of Bayes security against a target value, and deploying the machine-learning model only if the lower bound of Bayes security meets or exceeds the target value.

6. The method of claim 1, further comprising:
training at least one alternative machine-learning model on the training data records by DP-SGD with an associated set of training hyperparameters, and computing values of Bayes security against record-level inference of the attribute for the at least one alternative machine-learning model from gradient bounds with respect to values of the attribute computed during training of the at least one alternative machine-learning model in conjunction with values of the associated set of training hyperparameters; and
upon completion of training the machine-learning model and the at least one alternative machine-learning model, selecting for deployment, among the machine-learning model and the at least one alternative machine-learning model, a model having a highest associated final value of Bayes security.

7. The method of claim 1, wherein the set of training hyperparameters comprises: a sampling rate, a noise multiplier, and a gradient norm clipping parameter.

8. The method of claim 7, wherein the set of training hyperparameters further comprises: a number of training steps.

9. The method of claim 7, wherein the value of Bayes security is computed using the Gauss error function of an argument that comprises a combination of a norm of the gradient bounds computed during the training, the sampling rate, the noise multiplier, and the gradient norm clipping parameter.

10. The method of claim 1, wherein the data records are personal records for a plurality of people and the attributes comprise a demographic attribute.

11. The method of claim 10, wherein the data records are one of medical records for a plurality of patients or financial records for a plurality of people.

12. One or more machine-readable media storing processor-readable instructions which, when executed by one or more computer processors, cause the one or more computer processors to perform operations comprising:
training a machine-learning model with a differentially-private stochastic gradient descent (DP-SGD) algorithm on training data records comprising an attribute;
computing gradient bounds with respect to values of the attribute during training;
computing a value of Bayes security against record-level inference of the attribute from the gradient bounds in conjunction with values of a set of training hyperparameters of the DP-SGD algorithm; and
stopping training the machine-learning model once the value of Bayes security falls below a target value.

13. The one or more machine-readable media of claim 12, wherein training the machine-learning model comprises iteratively updating weights of the machine-learning model, the weights being stored over the course of multiple successive iterations, further comprising, once the value of Bayes security falls below the target value, restoring the weights of the machine-learning model associated with an earlier iteration of the multiple successive iterations.

14. The one or more machine-readable media of claim 12, wherein the set of training hyperparameters comprises: a sampling rate, a noise multiplier, and a gradient norm clipping parameter.

15. The one or more machine-readable media of claim 14, wherein the value of Bayes security is computed using a Gauss error function of an argument that comprises a combination of a norm of the gradient bounds computed during the training, the sampling rate, the noise parameter, and the gradient norm clipping parameter.

16. The one or more machine-readable media of claim 12, wherein the data records are personal records for a plurality of people and the attributes comprise a demographic attribute.

17. A system comprising:
one or more computer processors; and
one or more machine-readable media storing processor-readable instructions which, when executed by the one or more computer processors, cause the one or more computer processors to perform operations comprising:
training a machine-learning model with a differentially-private stochastic gradient descent (DP-SGD) algorithm on training data records comprising an attribute,
computing gradient bounds with respect to values of the attribute during training,
computing a value of Bayes security against record-level inference of the attribute from the gradient bounds in conjunction with values of a set of training hyperparameters of the DP-SGD algorithm, and
updating the values of the set of training hyperparameters to increase the value of Bayes security.

18. The system of claim 17, wherein the set of training hyperparameters comprises: a sampling rate, a noise multiplier, and a gradient norm clipping parameter.

19. The system of claim 17, wherein the value of Bayes security is computed using the Gauss error function of an argument that comprises a combination of a norm of the gradient bounds computed during the training, the sampling rate, the noise parameter, and the gradient norm clipping parameter.

20. The system of claim 17, wherein the data records are personal records for a plurality of people and the attributes comprise a demographic attribute.
